(19) United States
(12) Patent Application Publication
(10) Pub. No.: US 2014/0212685 A1
(43) Pub. Date: Jul. 31, 2014

(54) ENGINE OR ENGINE PART AND A METHOD OF MANUFACTURING THE SAME

(71) Applicant: Bayer International SA, Fribourg (CH)

(72) Inventors: Henning Zoz, Wenden (DE); Michael Dvorak, Thun (CH); Horst Adams, Allstatten (CH)

(73) Assignee: Bayer International SA, Fribourg (CH)

(21) Appl. No.: 14/230,311

(22) Filed: Mar. 31, 2014

Related U.S. Application Data
(63) Continuation of application No. 13/201,661, filed on Feb. 2, 2012, now abandoned.

(30) Foreign Application Priority Data
Feb. 16, 2009 (DE) 102009009110.6

(51) Int. Cl. B22F 7/00; B32B 15/04

(52) U.S. Cl. CPC B22F 7/008; B32B 15/043
USPC 428/636; 75/228; 75/243; 419/62; 419/30

(57) ABSTRACT

Disclosed herein is an engine 52, in particular a combustion engine or a jet-power unit, or an engine part 54, 56 made from metal, and in particular Al or Mg, or an alloy comprising one or more thereof. The engine or engine part is made from a compound material of said metal reinforced by nanoparticles, in particular CNT, wherein the reinforced metal has a microstructure comprising metal crystallites at least partly separated by said nanoparticles

### TECHNICAL FIELD

The present invention relates to an engine, in particular a combustion engine or a jet-power unit or a part thereof made from metal, and in particular a light metal such as Al, Mg or an alloy comprising one or more of the same. The invention also relates to a method for producing the same.

### BACKGROUND ART

Traditionally, combustion engines have been made from cast-iron, in particular grey iron, and these materials are still predominantly used in current car engine manufacturing. However, in a continuing effort to limit fuel consumption, the general trend in engine manufacturing is heading towards light metal engines, in particular those based on aluminum and magnesium alloys, which allow to save a considerable part of the vehicle's total weight and thus help to keep the fuel consumption low.

A major difficulty encountered when using light metals such as aluminum or magnesium for engines is their comparatively poor thermal stability, which leads to a phenomenon known as “creeping”. For example, in aluminum based engines, the motor block and cylinder head, both made from an aluminum alloy, will be attached to each other with steel screws fastened with a high torque, such that the motor block and the cylinder head are pressed against each other with a very high force. A high connection force is necessary in order to ensure air tightness of the engine cavities in spite of the very high gas pressures generated therein. The high attachment force leads to a considerable bond stress between the light metal engine parts, such as motor block and cylinder head, and the screw employed for connecting the same.

When the temperature of the engine parts increases upon operation of the engine, the “creeping phenomenon” will be induced in areas of highest bond stress, and due to the creeping, the bond stress will irreversibly be decreased. That is to say, even after the engine cools down and the creeping stops, the original bond stress will not be restored. Consequently, during longer use of the engine, the bond stress and thus the connection force between motor block and cylinder head will decrease and so will the air tightness of the volume enclosed thereby.

In a further effort to limit fuel consumption, the efficiency of the engines themselves is increased. There is an additional trend in the art of using smaller swept volumes in combustion engines but charging the intake air to higher pressures. If the engines are operated at high gas pressures, air tightness is even more difficult to ensure, and consequently high connection forces between engine parts become increasingly important. It is thus an object of the invention to provide an engine or parts thereof which allow to circumvent the aforementioned problems.

It is also an object of the invention to provide a method of manufacturing the engine or engine parts which are suitable for mass production at moderate costs.

### SUMMARY OF THE INVENTION

In order to meet the above objects, an engine or engine part is made from metal, in particular Al, Mg or an alloy comprising one or more thereof, wherein the engine or engine part is made from a compound material of the metal reinforced by nanoparticles, in particular CNT, wherein the reinforced metal has a microstructure comprising metal crystallites at least partly separated by said nanoparticles. Herein, the compound preferably comprises metal crystallites having a size in a range of 1 nm to 100 nm, preferably 10 nm to 100 nm, or in a range of more than 100 nm and up to 200 nm.

In the following, specific reference will be made to CNT as said nanoparticles for simplicity. It is however believed that similar effects could also be achieved when using other types of nanoparticles having a high aspect ratio, in particular inorganic nanoparticles such as carbides, nitrides and silicides. Thus, wherever applicable every disclosure made herein with respect to CNT is also contemplated with reference to other types of nanoparticles having a high aspect ratio, without further mention.

The structure of the material constituting the connection means has a new and surprising effect in that the micro structure of the metal crystallites is stabilized by the nanoparticles (CNT). In particular, it has been observed that due to a positioning of the CNT along the grain boundaries of the small, preferably nano scale metal crystallites, a dislocation movement can be suppressed and dislocations in the metal can be stabilized by the CNT. This stabilization is very effective due to the extremely high surface to volume ratio of the nano scale crystallites. Also, if alloys strengthened by solid-solution hardening are used as the metal constituents, the phases of the mixed crystal or solid solution can be stabilized by the engagement or interlocking with the CNT. Accordingly, this new effect which is observed to arise for small metal crystallites in combination with uniformly and preferably isotropically dispersed CNT is called “nano-stabilization” or “nano-fixation” herein. A further aspect of the nano-stabilization is that the CNT suppress a grain growth of the metal crystallites.

While the nano-stabilization is of course a microscopical (or rather nanoscopical) effect, it allows to produce a compound material as an intermediate product and to further manufacture a finished engine or engine part therefrom having unprecedented macroscopic mechanical properties. First of all, the compound material will have a mechanical strength that is significantly higher than that of the pure metal component.

A further surprising technical effect is an increased high-temperature stability of the compound material as well as of the engine parts produced therefrom. For example, it has been observed that due to the nano-stabilization of the nano crystallites by CNT, a dislocation density and an increased hardness associated therewith can be conserved at temperatures close to the melting point of some of the phases of the metal. This means that the problem of creeping encountered with current light metal engines can be dramatically reduced. If two parts of the engine are connected by a connection means with a high connection force, the bond stress between the connection means and the engine parts can be maintained even under extended operation at high temperatures, so that the connection force and thus the air tightness of the engine can be ensured for long times of operation. This is especially important for modern high efficiency combustion engines, in which the intake air is charged to extremely high pressures and where a durable sufficient degree of air tightness is currently difficult to achieve.

A further important technical effect is that due to the CNT, the heat conductivity of the compound material can be increased significantly as compared to that of the metal content itself, which allows to more efficiently dissipate excessive heat and to thus keep the temperature peaks at the engine part moderate. Accordingly, this also adds to avoid the abovementioned problem of creeping.

In some embodiments of the invention, the nanoparticles are not only partly separated from each other by the CNT, but some CNT are also contained or embedded in crystallites. One can think of this as a CNT sticking out like a “hair” from a crystallite. These embedded CNTs are believed to play an important role in preventing grain growth and internal relaxation, i.e. preventing a decrease of the dislocation density when energy is supplied in form of pressure and/or heat upon compacting the compound material, and to ensure the thermal stability of the compacted material. Using mechanical alloying techniques of the type as described below, it is possible to produce crystallites below 100 nm in size with embedded CNTs. In some instances, depending on the diameter of the CNTs, it may be easier to embed the CNTs in crystallites ranging between 100 nm and 200 nm in size. In particular, with the additional stabilization effect for the embedded CNTs, the nano-stabilisation has been found to be very effective also for crystallites between 100 nm and 200 nm in size.

As regards aluminum as a metal component of the engine part, the invention allows to circumvent many problems currently encountered with high strength Al alloys, for example with regard to corrosion. Namely, if pure aluminum or an aluminum alloy is used as the metal constituent of the composite material of the engine part, an aluminum based composite material can be provided which due to the nano-stabilization effect has a strength and hardness comparable with or even beyond the highest strength aluminum alloy available today, which also has an increased high-temperature strength due to the nano-stabilization and is open for anodic oxidation. If a high-strength aluminum alloy is used as the metal of the composite of the invention, the strength of the compound can even be further raised.

Also, by adequately adjusting the percentage of CNT in the composite, the mechanical properties can be adjusted to a desired value. Therefore, materials having the same metal component but different concentrations of CNT and thus different mechanical properties can be manufactured, which will have the same electro-chemical potential and therefore will not be prone to corrosion when connected with each other. This is different from prior art, where different alloys need to be used when different mechanical properties are needed, and where accordingly corrosion is always an issue when different alloys are brought in contact.

The present invention also provides an engine, such as a combustion engine or a jet-power unit comprising a first part, a second part and a connection means connecting the first and second parts, wherein at least one of said first and second parts is an engine part according to the above embodiments. In many situations, it will be necessary that the connection means has different, in particular superior mechanical properties as compared with the first and second parts that are to be connected thereby For example, currently high strength steel screws are typically used to connect light metal parts of an engine. Traditionally, this would imply that the connection means would be made from a metal or a metal alloy different from the metal or metal alloy of the first and/or second part having the desired mechanical properties in order to compensate for instance for different thermal expansion coefficients of the two parts to be connected. However, since the chemical potentials between the first and second parts and of the connection means will generally be different, the connection means will act as a galvanic element with regard to the parts, thus leading to contact corrosion in presence of an electrolyte.

In order to circumvent this problem, according to an embodiment of the present invention the connection means is also made from a compound material of a metal reinforced by nanoparticles. Since the mechanical properties of the connection means of the invention can be adjusted by the content of nanoparticles, it is in many cases possible to use the same metal component in the connection means as in the engine parts to be connected thereby and to still obtain suitably different mechanical properties. This way, contact corrosion between the first and/or second part on the one hand and the connection means on the other hand can be reliably avoided.

As a matter of fact, it is not necessary that the metal component of the first and/or second parts and the connection means are identical, but in practice it will often be sufficient that the respective chemical potentials deviate by less than 50 mV, preferably less than 25 mV from each other.

In summary, since in this embodiment, the content of nanoparticles of the connection means can be controlled to adjust the desired mechanical properties rather than the metal content used, this additional degree of freedom can be advantageously used to provide material connections in the engine employing a connection means which is both compatible with the engine parts to be connected from an electrochemical point of view and still provides the desired mechanical properties, which due to the nanoparticle content can be very different from that of the engine parts to be connected.

It has indeed been found that the tensile strength and the hardness can be varied approximately proportionally in a wide range with the content of CNT in the composite material. For light metals, such as aluminum, it has been found that the Vickers hardness increases nearly lineally with the CNT content. At a CNT content of above about 10.0 wt %, the composite material becomes extremely hard and brittle. Accordingly, depending on the desired mechanical properties, a CNT content from 0.5 to 10.0 wt % will be preferable. In particular, a CNT content in the range of 2.0 to 9.0% is extremely useful as it allows to make composite materials of extraordinary strength in combination with the aforementioned advantages of nano-stabilization, in particular high-temperature stability.

As has been explained above, according to one aspect of the invention, the mechanical properties of the connection means connecting a first and a second engine part can be specifically adapted without the necessity to use a different metal component, but by varying the nanoparticle content instead. The same principle is of course also applicable with regard to the first and second engine parts themselves, which each may be made from a compound material comprising metal or a metal alloy and nanoparticles, and where the mechanical properties of the two parts may be different due to different contents of nanoparticles. In a preferred embodiment, the numerical value of nanoparticles by weight of the first and second parts differ at least by 10%, preferably by at least 20% of the higher one of said numerical values. Thus, if the percentage of nanoparticles by weight would be 5% for the first part and 4% for the second part, the numerical values of the percentages would differ by 20% of the higher one of said numerical values.

It is mentioned that compound metal/CNT materials per se are for example from US 2007/0134496 A1, JP 2007/154 246 A, WO 2006/123 859 A1, WO 2008/052 642, WO 2009/010 297 and JP 2009/030 090. A detailed discussion thereof is made in the priority application PCT/EP2009/006 737, which is included herein by reference.

Also, in the priority application PCT/EP2009/006 737 an overview over prior art with regard to production of CNT is given, which is likewise included herein by reference

When the engine parts based on CNT reinforced metal are to be manufactured, there is a problem arising in prior art which is related to possible exposure when handling CNTs (see e.g. Baron P. A. (2003) “Evaluation of Aerosol Release During the Handling of Unrefined Single Walled Carbon Nanotube Material”, NIOSH DART-02-191 Rev. 1.1 April 2003; Maynard A. D. et al. (2004) “Exposure To Carbon Nanotube Material: Aerosol Release During The Handling Of Unrefined Singlewalled Carbon Nanotube Material”, Journal of Toxicology and Environmental Health, Part A, 67:87-107; Han, J. H. et al. (2008) ‘Monitoring Multiwalled Carbon Nanotube Exposure in Carbon Nanotube Research Facility’, Inhalation Toxicology, 20:8, 741-749).

According to a preferred embodiment, this can be minimized by providing the CNT in form of a powder of tangled CNT-agglomerates having a mean size sufficiently large to ensure easy handling because of a low potential for dustiness. Herein, preferably at least 95% of the CNT-agglomerates have a particle size larger than 100 μm. Preferably, the mean diameter of the CNT-agglomerates is between 0.05 and 5.0 mm, preferably 0.1 and 2.0 mm and most preferably 0.2 and 1.0 mm.

Accordingly, the nanoparticles to be processed with the metal powder can easily be handled with the potential for exposure being minimized. With the agglomerates being larger than 100 μm, they can be easily filtered by standard filters, and a low respirable dustiness in the sense of EN 15051-B can be expected. Further, the powder comprised of agglomerates of this large size has a pourability and flowability which allows an easy handling of the CNT source material.

While one might expect at first sight that it could be difficult to uniformly disperse the CNT on a nano scale while providing them in the form of highly entangled agglomerates on a millimetre scale, it has been confirmed by the inventors that a homogeneous and isotopic dispersion throughout the compound is in fact possible using mechanical alloying, which is a process of repeated deformation, fraction and welding of the metal and CNT particles. In fact, as will be explained below with reference to a preferred embodiment, the tangled structure and the use of large CNT-agglomerates even helps to preserve the integrity of the CNT upon the mechanical alloying at high kinetic energies.

Further, the length-to-diameter ratio of the CNT, also called aspect ratio, is preferably larger than 3, more preferably larger than 10 and most preferably larger than 30. A high aspect ratio of the CNT again assists in the nano-stabilization of the metal crystallites.

In an advantageous embodiment of the present invention, at least a fraction of the CNTs have a scrolled structure comprised of one or more rolled up graphite layers, each graphite layer consisting of two or more graphene layers on top of each other. This type of nano tubes has for the first time been described in DE 10 2007 044 031 A1 which has been published after the priority date of the present application. This new type of CNT structure is called a “multi-scroll” structure to distinguish it from “single-scroll” structures comprised of a single rolled-up graphene layer. The relationship between multi-scroll and single-scroll CNTs is therefore analogous to the relationship between single-wall and multi-wall cylindrical CNTs. The multi-scroll CNTs have a spiral shaped cross section and typically comprise 2 or 3 graphite layers with 6 to 12 graphene layers each.

The multi-scroll type CNTs have found to be extraordinarily suitable for the above mentioned nano-stabilization. One of the reasons is that the multi-scroll CNT have the tendency to not extend along a straight line but to have a curvy or kinky, multiply bent shape, which is also the reason why they tend to form large agglomerates of highly tangled CNTs. This tendency to form a curvy, bent and tangled structure facilitates the formation of a three-dimensional network interlocking with the crystallites and stabilizing them.

A further reason why the multi-scroll structure is so well suited for nano-stabilization is believed to be that the individual layers tend to fan out when the tube is bent like the pages of an open book, thus forming a rough structure for interlocking with the crystallites which in turn is believed to be one of the mechanisms for stabilization of defects.

Further, since the individual graphene and graphite layers of the multi-scroll CNT apparently are of continuous topology from the center of the CNT towards the circumference without any gaps, this again allows for a better and faster intercalation of further materials in the tube structure, since more open edges are available forming an entrance for intercalates as compared to single-scroll CNTs as described in Carbon 34, 1996, 1301-03, or as compared to CNTs having an onion type structure as described in Science 263, 1994, 1744-47.

In a preferred embodiment, at least a fraction of the nanoparticles are functionalized, in particular roughened prior to the mechanical alloying. When the nanoparticles are formed by multi-wall or multi-scroll CNTs, the roughening may be performed by causing at least the outermost layer of at least some of the CNTs to break by submitting the CNTs to high pressure, such as a pressure of 5.0 MPa or higher, preferably 7.8 MPa or higher, as will be explained below with reference to a specific embodiment. Due to the roughening of the nanoparticles, the interlocking effect with the metal crystallites and thus the nano-stabilization is further increased.

In a preferred embodiment, the processing of the metal particles and the nanoparticles is conducted such as to increase and stabilize the dislocation density of the crystallites by the nanoparticles sufficiently to increase the average Vickers hardness of the composite material to exceed the Vickers hardness of the original metal by 40% or more, preferably by 80% or more.

Also, the processing is conducted such as to stabilize the dislocations, i.e. suppress dislocation movement and to suppress the grain growth sufficiently such that the Vickers hardness of the connection means formed by compacting the composite powder is higher than the Vickers hardness of the original metal and preferably higher than 80% of the Vickers hardness of the composite powder.

The high dislocation density is preferably generated by causing numerous high kinetic energy impacts of balls of a ball mill. Preferably, in the ball mill the balls are accelerated to a speed of at least 8.0 m/s, preferably at least 11.0 m/s. The balls may interact with the processed material by shear forces, friction and collision forces, but the relative contribution of collisions to the total mechanical energy transferred to the material by plastic deformation increases with increasing kinetic energy of the balls. Accordingly, a high velocity of the balls is preferred for causing a high rate of kinetic energy impacts which in turn causes a high dislocation density in the crystallites.

Preferably, the milling chamber of ball mill is stationary and the balls are accelerated by a rotary motion of a rotating element. This design allows to easily and efficiently accelerate the balls to the above mentioned velocities of 8.0 m/s, 11.0 m/s or even higher, by driving the rotating element at a sufficient rotary frequency such that the tips thereof are moved at the above mentioned velocities. This is different from, for example, ordinary ball mills having a rotating drum or planetary ball mills, where the maximum speed of the balls is typically 5.0 m/s only. Also, the design employing a stationary milling chamber and a driven rotating element is easily scaleable, meaning that the same design can be used for ball mills of very different sizes, from laboratory type mill up to mills for high throughput mechanical alloying on an industrial scale.

Preferably, the axis of the rotary element is oriented horizontally, such that the influence of gravity on both, the balls and the processed material, is reduced to a minimum.

In a preferred embodiment, the balls have a small diameter of 3.0 to 8.0 mm, preferably 4.0 to 6.0 mm At this small ball diameters, the contact zones between the balls are nearly point shaped thus leading to very high deformation pressures, which in turn facilitates the formation of a high dislocation density in the metal.

The preferred material of the balls is steel, ZiO₂ or yttria stabilized ZiO₂.

The quality of the mechanical alloying will also depend on the filling degree of the milling chamber with the balls as well as on the ratio of balls and processed material. Good mechanical alloying results can be achieved if the volume occupied by the balls roughly corresponds to the volume of the chamber not reached by the rotating element. Thus, the filing degree of the balls is preferably chosen such that the volume V_{b} occupied by the balls corresponds to V_{b}=V_{c}−π.(r_{R})².l±20% , wherein V_{c} is the volume of the milling chamber, r_{R} is the radius of the rotating element and l is the length of the milling chamber in axial direction of the rotor. Also, the ratio of the processed material, i.e. (metal+nonparties)/balls by weight is preferably between 1:7 and 1:13.

While milling with high kinetic energy is advantageous with regard to increasing the dislocation density in the metal crystallites, high kinetic energies in practice lead to two severe problems. The first problem is that many metals due to their ductility will tend to stick to the balls, the chamber walls or the rotating element and thus not be processed further. This is especially true for light metals such as Al. Consequently, the part of the material that is not completely processed will not have the desired quality of the nano-stabilized CNT-metal composite, and the quality of products formed therefrom may be locally deficient, which may lead to breakage or failure of the finished article. Accordingly, it is of high importance that all of the material is completely and uniformly processed.

The second problem encountered when processing at high kinetic energies is that the CNT may be worn down or destroyed to an extent that the interlocking effect with the metal crystallites, i.e. the nano-stabilization no longer occurs.

To overcome these problems, in a preferred embodiment of the invention, the processing of the metal and the CNTs comprises a first and a second stage, wherein in the first processing stage most or all of the metal is processed and in the second stage CNTs are added and the metal and the CNTs are simultaneously processed. Accordingly, in the first stage, the metal can be milled down at high kinetic energy to a crystallite size of 100 nm or below before the CNTs are added, such as to not wear down the CNT in this milling stage. Accordingly, the first stage is conducted for a time suitable to generate metal crystallites having an average size in a range of 1 to 100 nm, which in one embodiment was found to be a time of 20 to 60 minutes. The second stage is then conducted for a time sufficient to cause a stabilization of the nanostructure of the crystallites, which may typically take 5 to 30 min only. This short time of the second stage is sufficient to perform mechanical alloying of the CNT and the metal and to thereby homogeneously disperse the CNT throughout the metal matrix, while not yet destroying too much of the CNT.

In order to avoid sticking of the metal during the first stage, it has proven to be very efficient to add some CNTs already during the first stage which may then serve as a milling agent preventing sticking of the metal component. This fraction of the CNT will be sacrificed, as it will be completely milled down and will not have any noticeable nano-stabilizing effect. Accordingly, the fraction of CNT added in the first stage will be kept as small as possible as long as it prevents sticking of the metal constituent.

In a further preferred embodiment, during the processing, the rotation speed of the rotating element is cyclically raised and lowered. This technique is for example described in DE 196 35 500 and referred to as “cycle operation”. It has been found that by conducting the processing with alternating cycles of higher and lower rotational speeds of the rotating element, sticking of the material during processing can be very efficiently be prevented. The cycle operation, which is per se known for example from the above referenced patent has proven to be very useful for the specific application of mechanical alloying of a metal and CNTs.

The method of manufacturing the connection means may also comprise the manufacturing of CNTs in the form of CNT powder as a source material. The method may comprise a step of producing the CNT powder by catalytic carbon vapor deposition using one or more of a group consisting of acetylene, methane, ethane, ethylene, butane, butene, butadylene, and benzene as a carbon donor. Preferably, the catalyst comprises two or more elements of a group consisting of Fe, Co, Mn, Mo and Ni. It has been found that with these catalysts, CNTs can be formed at high yield, allowing a production on an industrial scale. Preferably, the step of producing the CNT powder comprises a step of catalytic decomposition of C₁-C₃-carbo hydrogens at 500° C. to 1000° C. using a catalyst comprising Mn and Co in a molaric ratio in a range of 2:3 to 3:2. With this choice of catalyst, temperature and carbon donor, CNTs can be produced at high yield and in particular, in the shape of large agglomerates and with the preferred multi-scroll morphology.

The same advantages explained with regard to engine parts above also apply for gear wheels made from the same types of materials as described above with reference to engine parts.

### BRIEF DESCRIPTION OF THE FIGURES

FIG. 1 is a schematic diagram illustrating the production setup for high quality CNTs.

FIG. 2 is a sketch schematically showing the generation of CNT-agglomerates from agglomerated primary catalyst particles.

FIG. 3 is an SEM picture of a CNT-agglomerate.

FIG. 4 is a close-up view of the CNT-agglomerate of FIG. 3 showing highly entangled CNTs.

FIG. 5 is a graph showing the size distribution of CNT-agglomerates obtained with a production setup shown in FIG. 1

FIG. 6a is an SEM image of CNT-agglomerates prior to functionalization.

FIG. 6b is an SEM image of the same CNT-agglomerates after functionalization.

FIG. 6c is a TEM image showing a single CNT after functionalization.

FIG. 7 is a schematic diagram showing a setup for spray atomization of liquid alloys into an inert atmosphere.

FIGS. 8a and 8b show sectional side and end views respectively of a ball mill designed for high energy milling.

FIG. 9 is a conceptional diagram showing the mechanism of mechanical alloying by high energy milling.

FIG. 10 is a diagram showing the rotational frequency of the HEM rotor versus time in a cyclic operation mode.

FIG. 11a shows the nano structure of a compound of the invention in a section through a compound particle.

FIG. 11b shows, in comparison to FIG. 11a, a similar sectional view for the compound material as known from WO 2008/052642 A1 and WO 2009/010297 A1.

FIG. 12 shows an SEM image of the composite material according to an embodiment of the invention in which CNTs are embedded in metal crystallites.

FIG. 13 shows a schematic diagram of a material connection between engine parts according to an embodiment of the invention

### DESCRIPTION OF A PREFERRED EMBODIMENT

For the purposes of promoting an understanding of the principles of the invention, reference will now be made to the preferred embodiment illustrated in the drawings and specific language will be used to describe the same. It will, nevertheless, be understood that no limitation of the scope of the invention is thereby intended, such alterations and further modifications in the illustrated engine or engine parts, method and use and such further applications of the principles of the invention as illustrated therein being contemplated as would normally occur now or in the future to one skilled in the art to which the invention relates.

In the following, a processing strategy for manufacturing engine parts according to an embodiment of the invention is summarized. For this, a method of producing constituent materials and of producing a composite material from the constituent materials will be explained. Also, different ways of compacting the composite material such as to form an engine or engine parts or a blank for the same will be discussed.

In the preferred embodiment, the processing strategy comprises the following steps:

1.) production of high quality CNTs,

2.) functionalization of the CNTs,

3.) spray atomisation of liquid metal or alloys into inert atmosphere,

4.) high energy milling of metal powders,

5.) mechanical dispersion of CNTs in the metal by mechanical alloying,

6.) compacting of metal-CNT composite powders to form engine parts or blanks thereof, and

7.) further processing of engine parts or blanks.

Preferred embodiments of the above steps are described in detail below.

### PRODUCTION OF HIGH QUALITY CNTS

In FIG. 1, a setup 10 for producing high quality CNTs by catalytic CVD in a fluidized bed reactor 12 is shown. The reactor 12 is heated by heating means 14. The reactor 12 has a lower entrance 16 for introducing inert gases and reactant gases, an upper discharge opening 18 for discharging nitrogen, inert gas and by-products from the reactor 12, a catalyst entrance 20 for introducing a catalyst and a CNT discharge opening 22 for discharging CNTs formed in the reactor 12.

In a preferred embodiment, CNTs of the multi-scroll type are produced by a method as known from DE 10 2007 044 031 Al, which has been published after the priority date of the present application and the whole content of which is hereby included in the present application by reference.

First, nitrogen as an inert gas is introduced in the lower entrance 16 while the reactor 12 is heated by heating means 14 to a temperature of 650° C.

Next, a catalyst is introduced through catalyst entrance 20. Herein, the catalyst is preferably a transition metal catalyst based on Co and Mn, wherein the molaric ratio of Co and Mn with respect to each other is between 2:3 and 3:2.

Next, a reactant gas is introduced at the lower entrance 16, comprising a hydrocarbon gas as a carbon donor and an inert gas. Herein, the hydrocarbon gas preferably comprises C₁-C₃-carbo-hydrogens. The ratio of reactant and inert gas may be about 9:1.

Carbon deposited in form of CNT is discharged at the CNT discharge opening 22.

The catalyst material is typically milled to a size of 30 to 100 μm. As is shown in schematically in FIG. 2, a number of primary catalyst particles may agglomerate and carbon is deposited by CVD on the catalyst particle surfaces such that CNTs are grown. According to the preferred production method of the invention, the CNT form agglomerates of long entangled fibres upon growth, as is schematically shown in the right half of FIG. 2. At least part of the catalyst will remain in the CNT-agglomerate.

However, due to the very rapid and efficient growth of the CNT, the catalyst content in the agglomerates will become negligible, as the carbon content of the agglomerates may eventually be higher than 95%, in some embodiments even higher than 99%.

In FIG. 3, an SEM image of a CNT-agglomerate thus formed is shown. The agglomerate is very large by “nano-standards”, having a diameter of more than 1 mm. FIG. 4 shows an enlarged image of the CNT-agglomerate, in which a multitude of highly entangled CNTs with a large length to diameter ratio can be seen. As can be seen from FIG. 4, the CNTs have a “curly” or “kinky” shape, as each CNT has only comparatively short straight sections with numerous bends and curves inbetween. It is believed that this curliness or kinkiness is related to the peculiar structure of the CNTs, which is called the “multi-scroll structure” herein. The multi-scroll structure is a structure comprised of one or more rolled up graphite layers, where each graphite layer consists of two or more graphene layers on top of each other. This structure has for the first time been reported in DE 10 2007 044 031 A1 published after the priority date of the present application.

The below Table 1 summarizes the characteristic properties of high purity multi-scroll CNT that have been produced with the setup of FIG. 1.

TABLE 1

| Properties | Value | Unit | Method |
|---|---|---|---|
| C-Purity | >95 | wt % | ashing |
| Free amorphous carbon | — | wt % | TEM |
| Outer mean diameter | ~13 | nm | TEM |
| Inner mean diameter | ~4 | nm | TEM |
| Length | 1->10 | μm | SEM |
| Bulk density | 130-150 | kg/m³ | EN ISO 60 |

It is noted that the CNTs have a considerably high C-purity of more than 95wt %. Also, the average outer diameter is only 13 nm at a length of 1 to 10 μm, i.e. the CNTs have a very high aspect ratio. A further remarkable property is the high bulk density being in a range of 130 to 150 kg/m³. This high bulk density greatly facilitates the handling of the CNT-agglomerate powder, and allows easy pouring and efficient storing thereof. This is of great importance when it comes to application of the composite material for manufacturing connection means on an industrial scale.

The CNT-agglomerates with the properties of Table 1 can be produced rapidly and efficiently with a high throughput. Even today the applicant already has the capacity to produce 60 tons of this type of CNT-agglomerates per year.

Table 2 summarizes the same properties for a very high purity CNT-agglomerate which the applicant is also able to produce, although at a lower capacity.

TABLE 2

| Properties | Value | Unit | Method |
|---|---|---|---|
| C-Purity | >99 | wt % | ashing |
| Free amorphous carbon | — | wt % | TEM |
| Outer mean diameter | ~13 | nm | TEM |
| Inner mean diameter | ~4 | nm | TEM |
| Length | 1->10 | μm | SEM |
| Bulk density | 140-230 | kg/m³ | EN ISO 60 |

FIG. 5 shows a graph of the particle-size distribution of the CNT-agglomerates. The abscissa represents the particle size in μm, while the ordinate represents the cumulative volumetric content. As can be seen from the diagram in FIG. 5, almost all of the CNT-agglomerates have a size larger than 100 μm. This means that practically all of the CNT-agglomerates can be filtered by standard filters. These CNT-agglomerates have a low respirable dustiness under EN 15051-B. Thus, the extraordinarily large CNT-agglomerates used in the preferred embodiment of the invention allow for a safe and easy handling of the CNT, which again is of highest importance when it comes to transferring the technology from the laboratory to the industrial scale. Also, due to the large CNT-agglomerate size, the CNT powder has a good pourability, which also greatly facilitates the handling. Thus, the CNT-agglomerates allow to combine macroscopic handling properties with nanoscopic material characteristics.

2. FUNCTIONALIZATION OF CNT

In a preferred embodiment, the CNTs are functionalized prior to performing the mechanical alloying. The purpose of the functionalizing is to treat the CNTs such that the nano-stabilization of the metal crystallites in the composite material will be enhanced. In the preferred embodiment, this functionalization is achieved by roughening the surface of at least some of the CNTs.

Herein, the CNT-agglomerates as shown in FIG. 6a are submitted to a high pressure of 100 kg/cm² (9.8 MPa). Upon exerting this pressure, as is shown in FIG. 6b, the agglomerate structure as such is preserved, i.e. the functionalized CNTs are still present in the form of agglomerates preserving the aforementioned advantages with respect to low respirable dustiness and easier handling. Also, it is found that while the CNT retain the same inner structure, the outermost layer or layers burst or break, thereby developing a rough surface, as is shown in FIG. 6c. With the rough surface, the interlocking effect between CNT and crystallites is increased, which in turn increases the nano-stabilization effect.

3. METAL POWDER GENERATION THROUGH ATOMIZATION

In FIG. 7, a setup 24 for generating a metal powder through atomization is shown. The setup 24 comprises a vessel with heating means in which a metal or metal alloy to be used as a constituent of the composite material is melted. The liquid metal or alloy is poured into a chamber 30 and forced by argon driving gas, represented by an arrow 32 through a nozzle assembly 34 into a chamber 36 containing an inert gas. In the chamber 36, the liquid metal spray leaving the nozzle assembly 34 is quenched by an argon quenching gas 38, so that the metal droplets are rapidly solidified and form a metal powder 40 piling up on the floor of chamber 36. This powder forms the metal constituent of the composite material used for manufacturing connection means according to an embodiment of the invention.

4. HIGH ENERGY MILLING OF METAL POWDERS AND MECHANICAL DISPERSION OF CNT IN METAL

In order to form the composite material from the CNT produced as described in section 1 and functionalized as described in section 2 and from the metal powder produced as described in section 3, the CNTs need to be dispersed within the metal. In the preferred embodiment, this is achieved by a mechanical alloying carried out in a high energy mill 42, which is shown in a sectional side view in FIG. 8a and a sectional end view in FIG. 8b. The high energy mill 42 comprises a milling chamber 44 in which a rotating element 46 having a number of rotating arms 48 is arranged such that the rotary axis extends horizontally. While this is not shown in the schematic view of FIG. 8, the rotating element 46 is connected to a driving means such as to be driven at a rotational frequency of up to 1,500 RPM or even higher. In particular, the rotating element 46 can be driven at a rotational speed so that the radially outward lying tips of each arm 48 acquire a velocity of at least 8.0 m/s, preferably more than 11.0 m/s with respect to the milling chamber 44, which itself remains stationary. Although not shown in FIG. 8, a multitude of balls are provided in the milling chamber 44 as milling members. A close-up look of two balls 50 is shown in FIG. 9 to be described in more detail below. In the present example, the balls are made from steel and have a diameter of 5.1 mm. Alternatively, the balls 50 could be made from ZiO₂ or yttria stabilized said ZiO₂.

The filling degree of the balls within the high energy mill 42 is chosen such that the volume occupied by the balls corresponds to the volume of the milling chamber 44 that lies outside the cylindrical volume that can be reached by the rotating arms 48. In other words, the volume V_{b} occupied by the balls corresponds to V_{b}=V_{c}−π.(r_{R})².l, wherein V_{c} is the volume of the milling chamber 44, r_{R} is the radius of the rotating arms 48 and r is the length of the milling chamber 44 in axial direction. Similar high energy ball mills are disclosed in DE 196 35 500, DE 43 07 083 and DE 195 04 540 A1.

The principle of mechanical alloying is explained with reference to FIG. 9. Mechanical alloying is a process where powder particles 52 are treated by repeated deformation, fracture and welding by highly energetic collisions of grinding balls 50. In the course of the mechanical alloying, the CNT-agglomerates are deconstructed and the metal powder particles are fragmentized, and by this process, single CNTs are dispersed in the metal matrix. Since the kinetic energy of the balls depends quadratically on the velocity, it is a primary object to accelerate the balls to very high velocities of 10 m/s or even above. The inventors have analyzed the kinetics of the balls using high speed stroboscopic cinematopography and could confirm that the maximum relative velocity of the balls corresponds approximately to the maximum velocity of the tips of the rotating arms 48.

While in all types of ball mills the processed media are subjected to collision forces, shear forces and frictional forces, at higher kinetic energies the relative amount of energy transferred by collision increases. In the framework of the present invention, it is preferred that from the total mechanical work applied to the processed media, the relative contribution of collisions is as high as possible. For this reason, the high energy ball mill 42 shown in FIG. 8 is advantageous over ordinary drum-ball mills, planetary ball mills or attritors since the kinetic energy of the balls that can be reached is higher. For example, in a planetary ball mill or in an attritor, the maximum relative velocity of the balls is typically 5 m/s or below. In a drum-ball mill, where the balls are set in motion by rotation of the milling chamber, the maximum velocity of the balls will depend both on the rotational velocity and the size of the milling chamber. At low rotational speeds, the balls are moved in the so called “cascade mode”, in which the frictional and shear forces dominate. At higher rotational frequencies, the ball motion enters the so called “cataract mode”, in which the balls are accelerated due to gravity in a free fall mode, and accordingly, the maximum velocity will depend on the diameter of the ball mill. However, even for the largest drum-ball mills available, the maximum velocity will hardly surpass 7 m/s. Accordingly, the HEM design with a stationary milling chamber 44 and a driven rotating element 46 as shown in FIG. 8 is preferred.

When processing the metal powder at high kinetic energies, this has two effects that are connected with the strengthening of the composite material. The first effect is a decrease of crystallite size. According to the Hall-Petch equation, the yield stress σ_{y} increases inversely proportional with the square root of the crystallite diameter d, i.e.

$${σ}_{y} = {σ}_{o} + \frac{{K}_{y}}{\sqrt{d}} ,$$

wherein K_{y} is a material constant and σ₀ is the yield stress of the perfect crystal, or in other words, the resistance of the perfect crystal to dislocation motion. Accordingly, by decreasing the crystallite size, the material strength can be increased.

The second effect on the metal due to high energy collision is a work hardening effect due to an increase of dislocation density in the crystallites. The dislocations accumulate, interact with each other and serve as pinning points or obstacles that significantly impede their motion. This again leads to an increase in the yield strength σ_{y} of the material and a subsequent decrease in ductility.

Mathematically, the correlation between yield strength σ_{y} and dislocation density ρ can be expressed as follows:

σ_{y}=G.a.b. \sqrt{ρ},

where G is the shear modulus, b is the Burger's vector and a is a material specific constant.

However, many metals, in particular light metals such as aluminum have a fairly high ductility which makes processing by high energy milling difficult. Due to the high ductility, the metal may tend to stick at the inside wall of the milling chamber 44 or the rotating element 46 and may thereby not be completely milled. Such sticking can be counteracted by using milling aids such as stearin acids or the like. In WO 2009/010297 by the same inventors, it was explained that the CNT itself may act as a milling agent which avoids sticking of the metal powder. However, when the metal powder and the CNT are milled simultaneously at sufficient energy and for a sufficient duration such as to decrease the metal crystallite size to 100 nm or below, the CNT will tend to be damaged to a degree that the envisaged nano-stabilization is greatly compromised.

According to a preferred embodiment, the high energy milling is therefore conducted in two stages. In a first stage, the metal powder and only a fraction of the CNT powder are processed. This first stage is conducted for a time suitable to generate metal crystallites having an average size below 200 nm, preferably below 100 nm, typically for 20 to 60 min. In this first stage, a minimum amount of CNT is added that will allow to prevent sticking of the metal. This CNT is sacrificed as a milling agent, i.e. it will not have a significant nano-stabilizing effect in the final composite material.

In a second stage, the remaining CNT is added and the mechanical alloying of the CNTs and the metal is performed. In this stage, the microscopic agglomerates as shown in FIG. 3 and FIG. 6b need to be decomposed into single CNTs which are dispersed in the metal matrix by mechanical alloying. In experiments, it has been confirmed that it is in fact easily possible to deconstruct the CNT alloy by high energy milling, which would be difficult to achieve in alternative dispersion methods. Also, it has been observed that the integrity of the CNTs added during the second stage in the metal matrix is very good, thus allowing for the nano-stabilization effect. As regards the integrity of the disentangled CNTs in the metal matrix, it is believed that using agglomerates of larger size is even advantageous, since the CNTs inside the agglomerates are to a certain extent protected by the outside CNTs.

Further, in the first stage the rotational speed of the rotational element 46 is preferably cyclically raised and lowered as is shown in the timing diagram of FIG. 10. As is seen in FIG. 10, the rotating speed is controlled in alternating cycles, namely a high speed cycle at 1,500 rpm for the duration of 4 min and a low speed cycle at 800 rpm for a duration of one minute. This cyclic modulation of rotating speed is found to impede sticking. Such cycle operation has already been described in DE 196 35 500 and has been successfully applied in the framework of the present invention.

By the above described process, a powder composite material can be obtained in which metal crystallites having a high dislocation density and a mean size below 200 nm, preferably below 100 nm are at least partially separated and micro-stabilized by homogeneously distributed CNTs. FIG. 11a shows a cut through a composite material particle according to an embodiment of the invention. In FIG. 11a, the metal constituent is aluminum and the CNTs are of the multi-scroll type obtained in a process as described in section 1 above. As can be seen from FIG. 11a, the composite material is characterized by an isotropic distribution of nanoscopic metal crystallites located in a CNT mesh structure. In contrast to this, the composite material of WO 2008/052642 shown in FIG. 11b has a non-isotropic layer structure, leading to non-isotropic mechanical properties.

FIG. 12 shows an SEM image of a composite material comprised of aluminum with CNT dispersed therein. At locations denoted with number \textcircled{1}, examples of CNT extending along a boundary of crystallites can be seen. The CNTs separate individual crystallites from each other and thereby effectively suppress grain growth of the crystallites and stabilize the dislocation density. At locations marked with reference signs \textcircled{2}, CNTs can be seen which are contained or embedded within a nanocrystallite and stick out from the nanocrystallite surface like a “hair”. It is believed that these CNTs have been pressed into the metal crystallites like needles in the course of the high energy milling described above. It is believed that these CNTs embedded or contained within individual crystallites play an important role in the nano-stabilization effect, which in turn is responsible for the superior mechanical properties and thermal stability of the composite material and of compacted articles formed thereby.

In the preferred embodiment, the composite powder is subjected to a passivation treatment in a passivation vessel (not shown). In this passivation, the finished composite powder is discharged from the milling chamber 42, while still under vacuum or in an inert gas atmosphere and is discharged into the passivation vessel. In the passivation vessel, the composite material is slowly stirred, and oxygen is gradually added such as to slowly oxidize the composite powder. The slower this passivation is conducted, the lower is the total oxygen uptake of the composite powder.

Passivation of the powder again facilitates the handling of the powder as a source material for fabrication of manufactured or semi-finished articles on an industrial scale.

5. COMPACTING OF THE COMPOSITE MATERIAL POWDER

The composite material powder is then used as a source material for forming semi-finished or finished connection means by powder metallurgic methods. In particular, it has been found that the powder material of the invention can very advantageously be further processed by cold isostatic pressing (CIP) and hot isostatic pressing (HIP). Alternatively, the composite material can be further processed by hot working, powder milling or powder extrusion at high temperatures close to the melting temperature of some of the metal phases. It has been observed that due to the nano-stabilizing effect of the CNT, the viscosity of the composite material even at high temperatures is increased such that the composite material may be processed by powder extrusion or flow pressing. Also, the powder can be directly processed by continuous powder rolling.

It is a remarkable advantage of the composite material of the invention that the beneficial mechanical properties of the powder particles can be maintained in the compacted finished or semi-finished article. For example, when using multi-scroll CNT and Al5xxx, by employing a mechanical alloying process as described in section 4 above, a composite material having a Vickers hardness of more than 390 HV was obtained. Remarkably, even after compacting the powder material, the Vickers hardness remains at more than 80% of this value. In other words, due to the stabilizing nano structure, the hardness of the individual composite powder particles can largely be transferred to the compacted article. Prior to this invention, such a hardness in the compacted article was not possible.

6. ENGINE

FIG. 13 schematically shows a a part of a combustion engine comprising a first part 54, a second part 56 and a connection means 58 connecting the first and second parts. Herein, the first part 54 is a portion of an engine block and the second part 56 is a part of a cylinder head, which are attached to each other by the connection means 58.

In such an application, the ideal connection means would have a high mechanical strength, a high thermal stability and a light weight. Unfortunately, as mentioned above, prior art light metal alloys such as high strength Al-alloys will have a small weight and a high mechanical strength, but fail to provide for thermal stability. Also, the manufacturing of connection means from such high strength aluminum alloys is difficult and costly for the reasons given above. In addition, even if a suitable metal alloy is found which has the desired mechanical properties, there is a further problem that the electrochemical potentials between the connection means and each of the first and second parts would be different, which would lead to a contact corrosion in the presence of a suitable electrolyte.

However, in the material connection 52 of FIG. 13, a connection means 58 according to an embodiment of the invention is used, which allows to control the mechanical properties of the connection means 58 by the content of nanoparticles, in particular CNT, rather than by the metal part used. Accordingly, the material connection 52 can be made by using the same metal components in each of the first and second parts 54, 56 and the connection means 58, where the desired mechanical properties of the connection means 58 are provided by the nanoparticle content based on the above nano-stabilization effect, such that no galvanic potential difference between the parts 54, 56 and the connection means 58 exists. This way, contact corrosion can be reliably prevented without compromising the mechanical properties of the connection means 58.

In practice, it is not necessary that all the metal components involved in the material connection 52 are identical, as long the difference in electrochemical potentials is low enough such as to prevent contact corrosion during the intended use. In many cases, contact corrosion can be avoided if the difference in chemical potential is less than 50 mV, preferably 25 mV.

In order to provide air tightness of the engine, the engine block 54 and the cylinder head 56 need to be attached with a high attaching force, meaning that connection means 58, i.e. a screw, is fastened with a high torque, thus leading to a high bond stress between the thread of the screw 58 and the engine parts 54, 56. If ordinary light metal or light metal alloys based on Al or Mg were used for the engine block 54 and cylinder head 56, the material would tend to creep if the engine 52 heats up under operation. As a result of the creeping, the bond stress will relax, and the attachment force between cylinder head 56 and engine block 54 will decrease irreversibly. Although the creeping process will generally proceed slowly, the attachment force may significantly decrease during the lifetime of the engine, and consequently, the air tightness of the engine 52 will be compromised, thus leading to a decreased efficiency of the engine 52.

Using the engine parts 54, 56 of the present invention reinforced by nanoparticles, the thermal stability can be greatly increased due to the above described nano-stabilization effect. Accordingly, the material creep can be prevented and the abovementioned problem be avoided. While in the preferred embodiment the screw 58 would also be made from nano-stabilized light metal, please note that the problem of creeping under bond stress could already be solved when connecting the nano-stabilized engine parts 54, 56 with an ordinary high-strength steel screw.

It is further noted that the creep in material connections is only one problem encountered with lack of thermal stability of light metals in engines, and it is also noted that the use of the metal reinforced with nanoparticles in engines or engine parts has additional advantages related to the superior mechanical property, especially with regard to strength and Young's modulus.

Although a preferred exemplary embodiment is shown and specified in detail in the drawings and the preceding specification, these should be viewed as purely exemplary and not as limiting the invention. It is noted in this regard that only the preferred exemplary embodiment is shown and specified, and all variations and modifications should be protected that presently or in the future lie within the scope of protection of the appending claims.

1-49. (canceled)

50. An engine or an engine part made from a compound material of a metal reinforced by nanoparticles, wherein the reinforced metal has a microstructure comprising metal crystallites at least partly separated by said nanoparticles.

51. The engine part of claim 50, said engine part is selected from the group consisting of a cylinder head, cylinder block, a crankcase, and a moving part of said engine.

52. The engine or engine part of claim 50, wherein the compound material comprises metal crystallites having a size in a range of 1 nm to 100 nm or from 100 nm to 200 nm.

53. The engine or engine part of claim 50, wherein at least some of the metal crystallites also comprise nanoparticles.

54. The engine or engine part of claim 50, wherein the CNT content of the composite material by weight is in the range of 0.5 to 10.0%.

55. The engine or engine part of claim 50, wherein the nano particles are formed by CNTs, at least a fraction of which have a scroll structure comprised of one or more rolled up graphite layers, wherein each graphite layer consists of two or more graphene layers on top of each other.

56. The engine or engine part of claim 50, wherein at least a fraction of the nano particles are functionalized.

57. An engine comprising a first part, a second part and a connection means connecting the first and second parts,
wherein at least one of the first and second parts is an engine part according to claim 50, and
wherein the connections means is made from a compound material of a metal reinforced by nanoparticles,
wherein said metal or metal alloy of said at least one of said first and second parts is the same as the metal component of the connection means or has an electrochemical potential deviating from that of the metal component of the connection means by less than 50 mV.

58. The engine of claim 57, wherein at least two members of the group consisting of the first part, the second part and the connection means are made from a compound material of a metal or metal alloy reinforced by nanoparticles but have different concentrations of nanoparticles, wherein
the numerical values of the percentage of nanoparticles by weight of said two members differ at least by 10% of the higher one of said numerical values.

59. A method of manufacturing an engine part comprising the following steps:
producing a composite powder material, said material comprising a metal and nanoparticles,
said composite powder particles comprising metal crystallites at least partly separated from each other by said nano particles, and
a step of compacting the composite powder into a finished engine part or a blank for said engine part.

60. The method of claim 59, wherein the step of compacting the composite powder comprises hot isostatic pressing, cold isostatic pressing, powder extrusion, powder rolling, or sintering.

61. The method of claim 59, wherein the compound powder particles comprise light metal crystallites having a size in a range of 1 nm to 100 nm or from 100 nm to 200 nm.

62. The method of claim 59, further comprising a step of processing a metal powder and said nano particles by mechanical alloying such as to form said compound powder.

63. The method of claim 59, wherein said metal is a light metal.

64. The method of claim 59, wherein said nano particles are formed by carbon nano tubes (CNT) provided in form of a powder of tangled CNT agglomerates having a mean size sufficiently large to allow easy handling because of a low potential for dustiness.

65. The method of claim 59, wherein the length to diameter ratio of the nano particles is larger than 3.

66. The method of claim 59, wherein the CNT content of the composite material by weight is in a range of 0.5 to 10.0%.

67. The method of claim 59, wherein the nano particles are formed by CNTs, at least a fraction of which have a scrolled structure, comprised of one or more rolled up graphite layers, wherein each graphite layer consists of two or more graphene layers on top of each other.

68. The method of claim 59, wherein said processing of metal powder and nano particles comprises a first and a second processing stage,
wherein in the first processing stage, most or all of the metal is processed, and
wherein in the second stage, nano particles are added and the metal and the nano particles are simultaneously processed.

69. A gear wheel made from a compound material of a metal reinforced by nanoparticles, wherein the reinforced metal has a microstructure comprising metal crystallites at least partly separated by said nanoparticles.
